(19) United States
(12) Patent Application Publication
(10) Pub. No.: US 2024/0282249 A1
(43) Pub. Date: Aug. 22, 2024

(54) DISPLAY APPARATUS AND CONTROL METHOD THEREOF

(71) Applicant: SAMSUNG ELECTRONICS CO., LTD., Suwon-si (KR)

(72) Inventors: Junghyun YOON, Suwon-si (KR); Sungjin LIM, Suwon-si (KR); Seungjun JEONG, Suwon-si (KR)

(73) Assignee: SAMSUNG ELECTRONICS CO., LTD., Suwon-si (KR)

(21) Appl. No.: 18/545,668

(22) Filed: Dec. 19, 2023

Related U.S. Application Data
(63) Continuation of application No. PCT/KR23/20319, filed on Dec. 11, 2023.

(30) Foreign Application Priority Data
Feb. 21, 2023 (KR) 10-2023-0022960

(51) Int. Cl. G09G 3/32; G09G 3/3258

(52) U.S. Cl. CPC G09G 3/32; G09G 3/3258; G09G 2320/0238

(57) ABSTRACT

An display apparatus includes: a display panel; and a controller configured to: process source data, received from an external device, to control the display panel to display an image on a screen of the display panel, the source data including the image, identify a first aspect ratio of the screen of the display panel and a second aspect ratio of the image, based on the first aspect ratio being different from the second aspect ratio, determine, within the screen of the display panel, an image area where the image is displayed and a black area where the image is not displayed, and move the image area periodically or substantially periodically along a direction in which the black area is located within the screen of the display panel.

### CROSS-REFERENCE TO RELATED APPLICATIONS

This application is a by-pass continuation application of International Application No. PCT/KR2023/020319, filed on Dec. 11, 2023, which is based on and claims priority to Korean Patent Application No. 10-2023-0022960, filed on Feb. 21, 2023, in the Korean Intellectual Property Office, the disclosures of which are incorporated by reference herein their entireties.

### BACKGROUND

### 1. Field

The disclosure relates to a display apparatus capable of displaying an image and a control method thereof.

### 2. Description of the Related Art

A display apparatus includes a display panel, and can display an image by adjusting an amount of light emitted from pixels of the display panel. The display panel may be classified into a self-luminous display panel that emits light by itself according to an image, and a non-self-luminous display panel that blocks or passes light emitted from a separate light source according to an image. An example of the non-self-luminous display panel is a Liquid Crystal Display (LCD) panel.

An LCD includes a backlight unit that supplies light from the rear of a display panel, a liquid crystal layer that acts as a switch to pass/block light, and a color filter that changes the supplied light to the desired color. Accordingly, the LCD has a complex structure and has a limited implementation (e.g., small thickness).

On the other hand, a Light Emitting Diode (LED), which is a representative self-luminous display, includes a pixel that emits light by itself. The LED does not require components such as a backlight unit and a liquid crystal layer and may exclude a color filter. Accordingly, the self-luminous display like the LED may have a simple structure and a high degree of design freedom. The self-luminous display may also realize thin thickness as well as excellent contrast ratio, brightness and viewing angle.

For self-luminous displays, panel deterioration occurs depending on usage. In particular, image retention may occur due to differences in luminance between an image area where the image is displayed and a black area where no image is displayed. When the image does not fill an entire screen of the display panel, a black area where no image is displayed is generated. When an image area where the image is displayed and a black area are displayed for a long time, image retention may occur at a boundary between the image area and the black area.

### SUMMARY

Provided are a display apparatus that may reduce local deterioration of a display panel of a self-luminous display and an occurrence of image retention, and a control method thereof.

According to an aspect of the disclosure, a display apparatus includes: a display panel; and a controller configured to: process source data, received from an external device, to control the display panel to display an image on a screen of the display panel, the source data including the image, identify a first aspect ratio of the screen of the display panel and a second aspect ratio of the image, based on the first aspect ratio being different from the second aspect ratio, determine, within the screen of the display panel, an image area where the image is displayed and a black area where the image is not displayed, and move the image area periodically or substantially periodically along a direction in which the black area is located within the screen of the display panel.

The controller may be further configured to: based on the black area being located above or below the image area, move the image area in a vertical direction, or based on the black area being located on a left side or a right side of the image area, move the image area in a horizontal direction.

The controller may be further configured to move the image area in a first direction or a second direction opposite to the first direction by a predetermined amount of movement at each predetermined movement period within a predetermined movement range.

The controller may be further configured to move the image area by a unit pixel at each predetermined movement period.

The controller may be further configured to: determine an accumulated amount of movement by adding the predetermined amount of movement each time the image area is moved in the first direction, move the image area in the first direction until the accumulated amount of movement reaches a maximum absolute value of the predetermined movement range, and based on the accumulated amount of movement reaching the maximum absolute value of the predetermined movement range, move the image area in the second direction.

The controller may be further configured to subtract, from the accumulated amount of movement, the predetermined amount of movement each time the image area is moved in the second direction.

The controller may be further configured to: based on display of the image being stopped, store a final position of the image area, and based on a first input of a command to resume displaying the image or based on a second input of another source data including another image having a same aspect ratio as the second aspect ratio of the image, determine a movement of the image area from the final position of the image area.

According to an aspect of the disclosure, a control method of a display apparatus including a display panel, the control method includes: identifying a first aspect ratio of a screen of the display panel and a second aspect ratio of an image to be displayed on the screen; based on the first aspect ratio being different from the second aspect ratio, determining, within the screen of the display panel, an image area where the image is displayed and a black area where the image is not displayed; and moving the image area periodically or substantially periodically along a direction in which the black area is located within the screen of the display panel.

The moving the image area may include: based on the black area being located above or below the image area, moving the image area in a vertical direction; and based on the black area being located on a left side or a right side of the image area, moving the image area in a horizontal direction.

The moving the image area may include moving the image area in a first direction or a second direction opposite to the first direction by a predetermined amount of movement at each predetermined movement period within a predetermined movement range.

The moving the image area may include moving the image area by a unit pixel at each predetermined movement period.

The moving the image area may include: determining an accumulated amount of movement by adding the predetermined amount of movement each time the image area is moved in the first direction; moving the image area in the first direction until the accumulated amount of movement reaches a boundary value of the predetermined movement range, and based on the accumulated amount of movement reaching the boundary value of the predetermined movement range, moving the image area in the second direction.

The moving the image area in the second direction may include subtracting, from the accumulated amount of movement, the predetermined amount of movement each time the image area is moved in the second direction.

The control method may further include: based on the image being stopped displayed on the image area of the display panel, storing a final position of the image area; and based on a first input of a command to resume displaying the image or a second input of another source data including another image having a same aspect ratio as the second aspect ratio of the image, determining movement of the image area from the final position of the image area.

According to an aspect of the disclosure, display apparatus includes: a display panel including a screen: a memory storing at least one instruction; and at least one processor operatively connected to the display panel and the memory, wherein the at least one processor is configured to execute the at least one instruction to: receive source data from an external device, control the display panel to display an image on the screen, wherein the image is included in the source data, identify a first aspect ratio of the screen and a second aspect ratio of the image, based on the first aspect ratio being different from the second aspect ratio, determine an image area where the image is displayed and a plurality of black areas where the image is not displayed, and move the image area periodically or substantially periodically along a plurality of directions in which the plurality of black areas are located.

The at least one processor may be further configured to execute the at least one instruction to: based on the plurality of black areas being located above and below the image area, move the image area in a vertical direction, or based on the plurality of black areas being located on a left side and a right side of the image area, move the image area in a horizontal direction.

The at least one processor may be further configured to execute the at least one instruction to move the image area in a first direction or a second direction opposite to the first direction by an amount of movement at a movement period within a movement range.

The at least one processor may be further configured to execute the at least one instruction to move the image area by a unit pixel at the movement period.

The at least one processor may be further configured to execute the at least one instruction to: determine an accumulated amount of movement by adding the amount of movement each time the image area is moved in the first direction, move the image area in the first direction until the accumulated amount of movement reaches a maximum absolute value of the movement range, and based on the accumulated amount of movement reaching the maximum absolute value of the movement range, move the image area in the second direction.

The at least one processor may be further configured to execute the at least one instruction to subtract, from the accumulated amount of movement, the amount of movement each time the image area is moved in the second direction.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an appearance of a display apparatus according to an embodiment;

FIG. 2 is an exploded view of a display apparatus according to an embodiment:

FIG. 3 is a control block diagram of a display apparatus according to an embodiment:

FIG. 4 illustrates a driving circuit for driving pixels of a display panel according to an embodiment:

FIG. 5 illustrates a configuration of a pixel circuit shown in FIG. 4;

FIG. 6 illustrates an example of moving an image area within a screen of a display panel:

FIG. 7 illustrates another example of moving an image area within a screen of a display panel:

FIG. 8 is a flowchart illustrating a control method of a display apparatus according to an embodiment:

FIG. 9 is a flowchart illustrating the control method of the display apparatus of FIG. 8 in more detail; and

FIG. 10 is a flowchart illustrating a method of determining a position of an image area after display of an image stops.

### DETAILED DESCRIPTION

Like reference numerals refer to like elements throughout the specification. Well-known functions or constructions are not described in detail since they would obscure the one or more exemplar embodiments with unnecessary detail. Terms such as “unit”, “module”, “member”, and “block” may be embodied as hardware or software. According to embodiments, a plurality of “unit”, “module”, “member”, and “block” may be implemented as a single component or a single “unit”, “module”, “member”, and “block” may include a plurality of components.

Terms such as “unit”, “part”, “block”, “member”, and “module” indicate a unit for processing at least one function or operation. For example, those terms may refer to at least one process processed by at least one hardware such as Field Programmable Gate Array (FPGA), Application Specific Integrated Circuit (ASIC), at least one software stored in a memory or a processor.

When an element is referred to as being “connected” another element, it can be directly or indirectly connected to the other element, wherein the indirect connection includes “connection via a wireless communication network”. Also, when a part “includes” or “comprises” an element, unless there is a particular description contrary thereto, the part may further include other elements, not excluding the other elements. Throughout the description, when a member is “on” another member, this includes not only when the member is in contact with the other member, but also when there is another member between the two members.

Although the terms first, second, third, etc., may be used herein to describe various elements, but elements are not limited by these terms. It is to be understood that the singular forms include plural forms as well, unless the context clearly dictates otherwise.

Reference numerals used for method steps are just used for convenience of explanation, but not to limit an order of the steps. Thus, unless the context clearly dictates otherwise, the written order may be practiced otherwise.

The term “or” is an inclusive term meaning “and/or”. The phrase “associated with,” as well as derivatives thereof, refer to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” refers to any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of A, B, and C” includes any of the following combinations: A, B, C, A and B, A and C, B and C, and A and B and C, and any variations thereof. The expression “at least one of a, b, or c” may indicate only a, only b, only c, both a and b, both a and c, both b and c, or all of a, b, and c. Similarly, the term “set” means one or more. Accordingly, the set of items may be a single item or a collection of two or more items.

Hereinafter, embodiments of the disclosure will be described in detail with reference to the accompanying drawings.

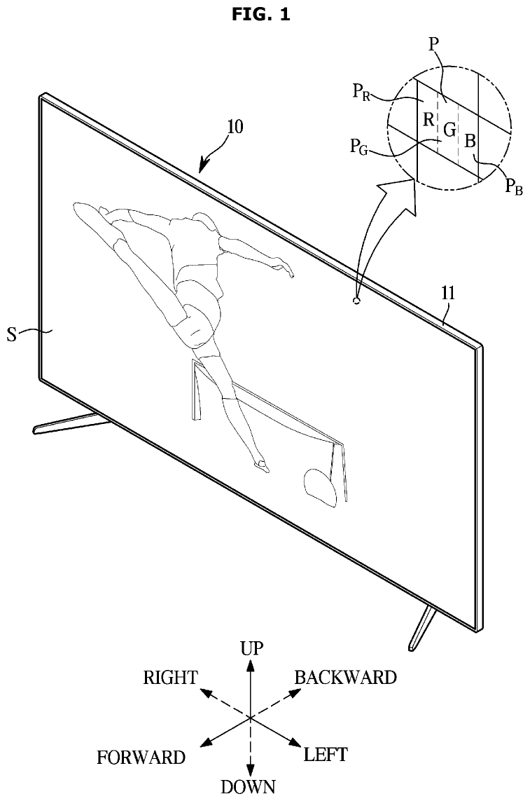

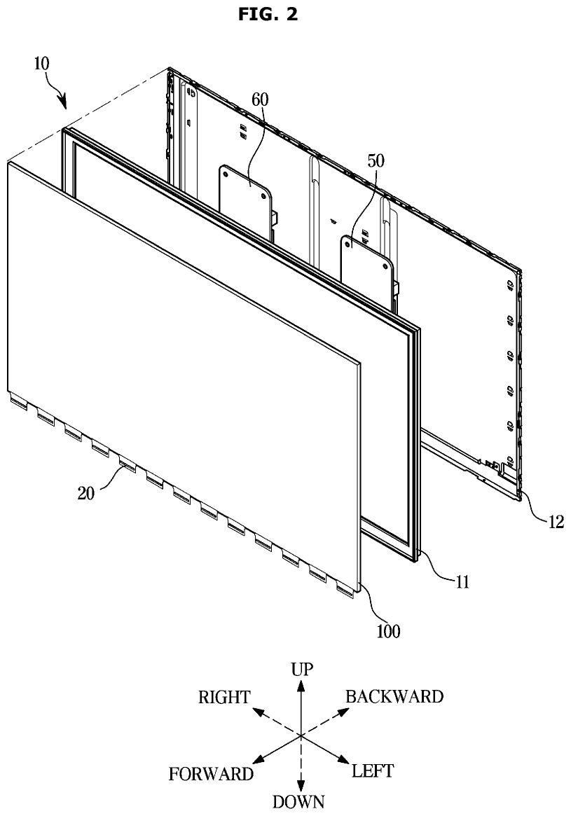

FIG. 1 illustrates an appearance of a display apparatus according to an embodiment. FIG. 2 is an exploded view of the display apparatus according to an embodiment.

Referring to FIG. 1 and FIG. 2, a display apparatus 10 may include a frame 11, a rear cover 12 and a display panel 100. The frame 11 may support the display panel 100. The rear cover 12 may be coupled to the frame 11, and may support and fix the frame 11 and the display panel 100. A control board 50 for controlling an operation of the display apparatus 10 and a power board 60 for supplying power to components of the display apparatus 10 may be provided on the rear cover 12.

Multiple images may be displayed on a screen S of the display panel 100. For example, a still image or moving image may be displayed on the screen S of the display panel 100. In addition, a two-dimensional image or a three-dimensional image using the parallax of both eyes of a user may be displayed on the screen S of the display panel 100.

A plurality of pixels P may be formed on the screen S of the display panel 100, and an image displayed on the screen S may be formed by a combination of light emitted from the plurality of pixels P. In an embodiment, the plurality of pixels P may be arranged in a matrix form. That is, the plurality of pixels P may be arranged in a plurality of rows and a plurality of columns. Light emitted by the plurality of pixels P may be combined as a mosaic to form an image. Each of the plurality of pixels P may emit light of various brightness and colors. In order to emit light of various colors, each of the plurality of pixels P may include sub-pixels P_{R}, P_{G}, and P_{B}.

A single pixel P may include a red sub-pixel P_{R} to emit red light, a green sub-pixel P_{G} to emit green light, and a blue sub-pixel P_{B} to emit blue light, respectively. By combining the red light from the red sub-pixel P_{R}, the green light from the green sub-pixel P_{G}, and the blue light from the blue sub-pixel P_{B}, the pixel P may emit light having various brightness and various colors.

The arrangement of the subpixels P_{R}, P_{G}, and P_{B} may vary. For example, the red sub-pixel P_{R}, the green sub-pixel P_{G}, and the blue sub-pixel P_{B} may be arranged in a line, but is not limited thereto. In an embodiment, the size of each of the red sub-pixel P_{R}, the green sub-pixel P_{G}, and the blue sub-pixel P_{B} may be the same as each other or different from each other.

In an embodiment, the unit pixel P may not necessarily include all of the red sub-pixel P_{R}, the green sub-pixel P_{G}, and the blue sub-pixel P_{B}. The pixel P may include a sub-pixel to emit yellow light or white light. That is, the color or type of light output from each sub-pixel and the number of sub-pixels may vary depending on the design of the pixel P.

In an embodiment, the display apparatus 10 is a self-luminous display apparatus in which each pixel emits light by itself without a backlight unit. For example, Organic Light Emitting Diodes (OLEDs) emitting light of different colors may be disposed in each sub-pixel. For example, a red OLED may be disposed in the red sub-pixel P_{R}, a green OLED may be disposed in the green sub-pixel P_{G}, and a blue OLED may be disposed in the blue sub-pixel P_{B}. Accordingly, a single sub-pixel may represent a single OLED. A plurality of pixels including the OLEDs may be independently driven.

A cable 20 may be connected to one side of the display panel 100. In an embodiment, the display panel 100 may include a plurality of cables 20. The cable 20 may electrically or operatively connect the display panel 100 to the control board 50 and the power board 60. The cable 20 may be a Flexible Flat Cable (FFC) and/or a film cable. The display panel 100 may receive a driving signal transmitted from the control board 50 through the cable 20. Further, the display panel 100 may receive power supplied from the power board 60 through the cable 20.

The control board 50 may include a control circuit for controlling operations of the display apparatus 10. The control circuit may generate an image signal by processing source data received from an external device and may generate a driving signal for driving the display panel 100. The power board 60 may supply power to components of the display apparatus 10. The power board 60 may be electrically connected to the control board 50 and the display panel 100 and supply power to the control board 50 and the display panel 100, respectively.

The control board 50 and the power board 60 may each include a processor and a memory. One or more processors and memories may be provided. The control board 50 and the power board 60 may be implemented with a printed circuit board and various circuits mounted on the printed circuit board. For example, the control board 50 may include a control circuit board on which at least one processor and at least one memory are mounted. The power board 60 may include the power circuit board on which components such as at least one capacitor, at least one coil, at least one resistor, and/or at least one processor are mounted.

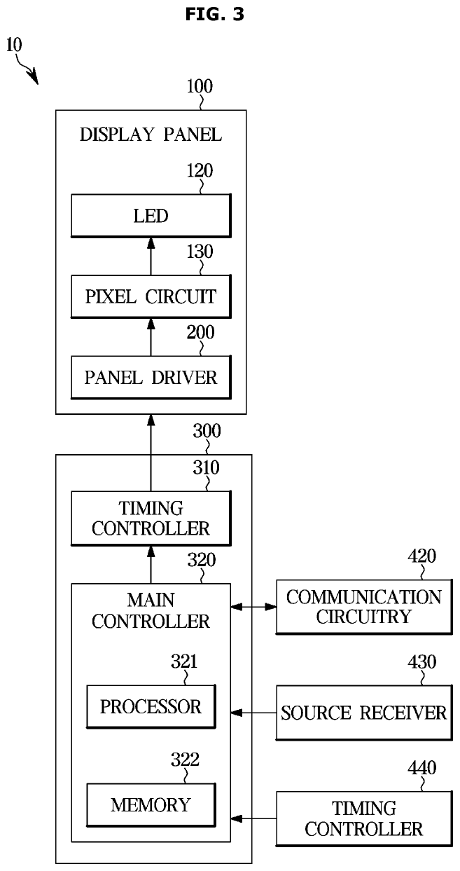

FIG. 3 is a control block diagram of the display apparatus according to an embodiment.

Referring to FIG. 3, the display apparatus 10 may include the display panel 100, a controller 300, a communication circuitry 420, a source receiver 430, and an input interface 440. The controller 300, the communication circuitry 420, the source receiver 430, and the input interface 440 may be arranged on the control board 50 described above. Components of the display apparatus 10 may be electrically connected to each other.

The display panel 100 may include a Light Emitting Diode (LED) 120, a pixel circuit 130 and a panel driver 200. The display panel 100 may be provided as a self-luminous display panel. That is, in an embodiment, the LED 120 forming the display panel 100 may be an Organic LED (OLED). As described above, the display panel 100 may include a plurality of pixels P, and each pixel may include a plurality of sub-pixels P_{R}, P_{G}, and P_{B}. In an embodiment, the LED 120 may be disposed in the sub-pixel.

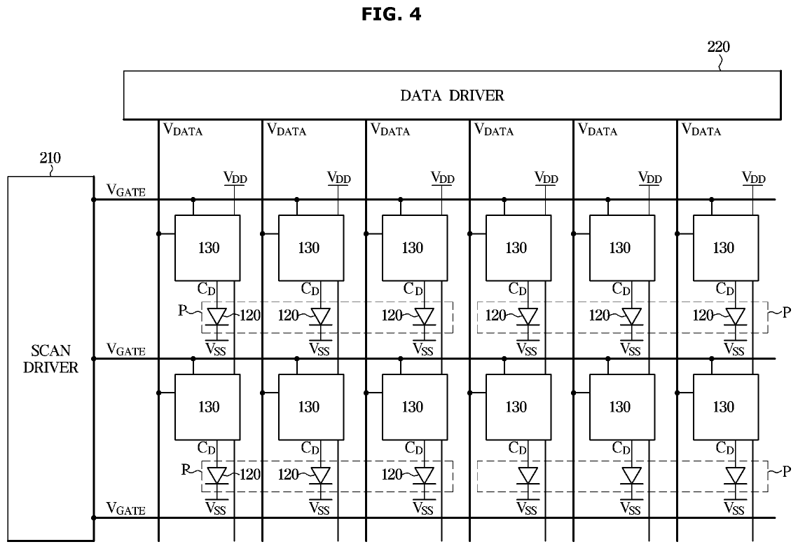

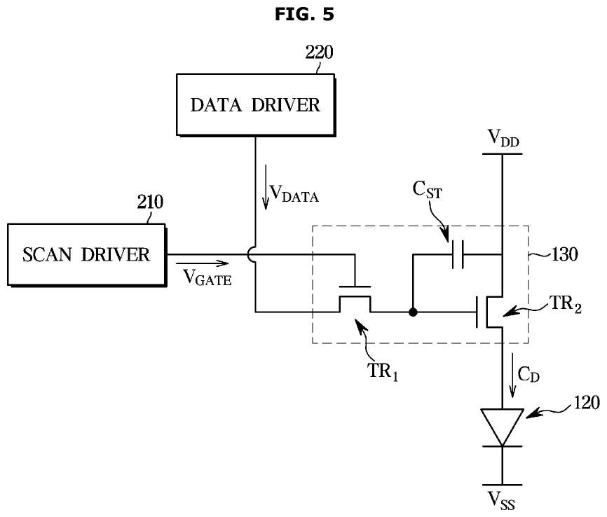

The pixel circuit 130 may output a driving current for driving the LED 120. The panel driver 200 may include a scan driver 210 applying a gate voltage to the pixel circuit 130 and a data driver 220 applying a data voltage to the pixel circuit 130. The pixel circuit 130 may be connected to the panel driver 200 and output a driving current for driving the LED 120 based on application of a gate voltage and a data voltage. The driving current (output from the pixel circuit 130) may be applied to the LED 120, and then, the LED 120 may emit light by the applied driving current. The plurality of LEDs 120 may be independently driven. The pixel circuit 130 and the panel driver 200 will be described in detail with reference to FIG. 4 and FIG. 5.

The controller 300 may control operations of the display apparatus 10. The controller 300 may process source data received from an external device to control the display panel 100 to display an image on a screen S of the display panel 100. The controller 300 may process the source data to generate an image signal, and generate a driving signal for driving the display panel 100. In an embodiment, the controller 300 may include a timing controller 310 and a main controller 320.

The timing controller 310 may receive the image signal from the main controller 320 and generate the driving signal for controlling driving of the display panel 100 based on the image signal. The timing controller 310 may transmit the driving signal to the panel driver 200 of the display panel 100. The driving signal generated by the timing controller 310 may include a scan control signal for controlling an operation of the scan driver 210 and a data control signal for controlling an operation of the data driver 220. In an embodiment, the timing controller 310 may include a processor and a memory.

The main controller 320 may control operations of electronic components included in the display apparatus 10. The main controller 320 may include at least one processor 321 and at least one memory 322. The at least one processor 321 may generate an image signal, an audio signal, and/or a control signal for controlling the operation of the display apparatus 10 based on instructions, applications, data, and/or programs stored in the at least one memory 322. The image signals and control signals generated by the main controller 320 may be transmitted to the timing controller 310.

In an embodiment, the at least one processor 321 is hardware and may include a logic circuit and an arithmetic circuit. The at least one memory 322 and the at least one processor 321 may be implemented as one control circuit or as a plurality of circuits. The at least one memory 322 may store various information required for the operation of the display apparatus 10. The at least one memory 322 may store programs, data, instructions, software and/or applications for controlling the operation of the display apparatus 10. The at least one memory 322 may include a volatile memory such as a Static Random Access Memory (S-RAM) or a Dynamic Random Access Memory (D-RAM) for temporarily storing data. In addition, the at least one memory 322 may include a non-volatile memory such as a Read Only Memory (ROM), an Erasable Programmable Read Only Memory (EPROM), or an Electrically Erasable Programmable Read Only Memory (EEPROM) for long-term storage of data.

In an embodiment, the communication circuitry 420 may communicate with an external device (e.g., a server, and a smartphone). The communication circuitry 420 may include a wireless communication circuit to which various wireless communication technologies are applied such as 3G communication, 4G communication, wireless Local Area Network (LAN), Wi-Fi, Bluetooth, Zigbee, Wi-Fi Direct (WFD), Ultra-Wide Band (UWB), infrared communication, Bluetooth Low Energy (BLE), Near Field Communication (NFC) and/or Z-Wave. In addition, the communication circuitry 420 may include a wired communication circuit to which a wired communication technology, such as Peripheral Component Interconnect (PCI), PCI-express, and/or Universe Serial Bus (USB), is applied. The communication circuitry 420 may transmit, to the main controller 320, source data including image data and/or audio data transmitted from an external device.

In an embodiment, the source data may also be obtained through the source receiver 430. The source receiver 430 may receive source data (including image data and/or audio data) from an external device. For example, the source receiver 430 may include various types of terminals such as a component (YPbPr/RGB) terminal, a Composite Video Blanking and Sync (CVBS) terminal, an audio terminal, a High-Definition Multimedia Interface (HDMI) terminal, and a Universal Serial Bus (USB) terminal. The source receiver 430 may transmit the source data (received from an external content source or the external device) to the main controller 320.

In an embodiment, the main controller 320 may generate an image signal and/or an audio signal by processing the source data. The main controller 320 may identify an aspect ratio of an image to be displayed on the screen S of the display panel 100 from the source data. The main controller 320 may generate a full-screen signal for displaying an image on the entire screen S or a partial-screen signal for displaying an image on a portion of the screen S, depending on the aspect ratio of the image. The timing controller 310 may generate a full driving signal for driving all pixels of the display panel 100 in response to receiving the full-screen signal. In addition, in response to receiving the partial-screen signal, the timing controller 310 may generate a partial driving signal for driving a portion of pixels of the display panel 100, but not driving the remaining pixels of the display panel 100. Because some pixels are not driven, a black area (having those pixels) may appear within the screen S. The above functions that are described to be performed by the main controller 320 may be performed by the at least one processor 321 included in the main controller 320.

In an embodiment, the input interface 440 may multiple various physical buttons and/or touch buttons provided on one area of the display apparatus 10. When the display panel 100 includes a touch screen panel, the display panel 100 may serve as the input interface 440. Further, the input interface 440 may be implemented as a remote controller. The input interface 440 may obtain a user input for controlling the display apparatus 10, for example, power on, power off, volume control, channel control, screen control, and various setting changes of the display apparatus 10.

In addition to the components described in FIG. 3, the display apparatus 10 may further include various components. For example, the display apparatus 10 may further include a speaker to output sound.

The controller 300 of the display apparatus 10 may identify a screen ratio of the screen S of the display panel 100 and a screen ratio of an image to be displayed on the screen S. For example, the ‘screen ratio’ refers to a ratio of width-to-height or a ratio of height-to-width. In other words, the controller 300 may identify a first aspect ratio of the screen S of the display panel 100 and a second aspect ratio of the image to be output on the screen S. The first aspect ratio of the screen S is determined upon manufacturing the display apparatus 10, and information about the first aspect ratio of the screen S may be stored in the at least one memory 322.

Based on the first aspect ratio of the screen S of the display panel 100 being the same as the second aspect ratio of the image to be output on the screen S, the controller 300 may control the display panel 100 to display the image on the entire screen S. For example, based on the first aspect ratio of the screen S and the second aspect ratio of the image being both 16:9, the image may be displayed on the entire screen S of the display panel 100. That is, the image area in which the image is displayed is the same as the screen S of the display panel 100.

Based on the first aspect ratio of the screen S of the display panel 100 being different from the second aspect ratio of the image to be output on the screen S, the controller 300 may determine, within the screen S of the display panel 100, the image area in which the image is displayed and a black area in which the image is not displayed.

For example, based on the first aspect ratio of the screen S being 16:9 and the second aspect ratio of the image being 4:3, the controller 300 may control the display panel 100 to generate a first black area on a left side and a second block area on a right side within the screen S. That is, the two black areas may be located on the left side and the right side of the image area in which the image is displayed. In this case, black areas are not generated above and below the image area.

In another example, based on the first aspect ratio of the screen S and the second aspect ratio of the image being 16:9 and 21:9, respectively, the controller 300 may control the display panel 100 to generate black areas in an upper side and a lower side within the screen S. That is, the black areas may be located above and below the image area in which the image is displayed. In this case, no black area is generated on the left side and the right side of the image area.

As such, based on the first aspect ratio of the screen S of the display panel 100 and the second aspect ratio of the image to be output on the screen S being different from each other, black areas (where no image is displayed) may be generated in the upper side and the lower side, or in the left side and the right side of the screen S of the display panel 100. In a case where a position of the image area and a position of the black area in the screen S of the display panel 100 are fixed for a long period of time, image retention may occur at a boundary of the image area and the black area.

To prevent the above, the controller 300 of the display apparatus 10 may periodically or substantially periodically move the image area along a direction in which the black area is located within the screen S of the display panel 100. For example, the controller 300 may move the image area in a vertical direction based on the black areas being located above and below the image area. The controller 300 may move the image area in a horizontal direction based on the black areas being located on the left side and the right side of the image area.

The controller 300 may move the image area in a first direction or in a second direction opposite to the first direction by a predetermined amount of movement at each predetermined movement period within a predetermined movement range. For example, in a case where the black areas are located above and below the image area, the first direction may be an upward direction and the second direction may be a downward direction. In a case where the black areas are located on the left side and the right side of the image area, the first direction may be a right direction and the second direction may be a left direction.

The (predetermined) movement range, the amount of (predetermined) movement, and the (predetermined) movement period of the image area may vary by design. In an embodiment, the amount of movement may be set in units of pixels. That is, the entire image area may be moved by one pixel at each movement period. Based on the movement period being set to 33 seconds, the controller 300 may move the entire image area by one pixel at every 33 second. In an embodiment, the movement range may be set between 8 pixels to the left and 8 pixels to the right from a center of the screen S of the display panel 100. In other words, considering the center of the screen S as the zero point, the movement range of the image area may be set from −8th pixel to +8th pixel. Boundary values of the movement range may be −8 and +8. That is, a lower limit of the movement range may be set to −8 pixel, an upper limit of the movement range may be set to +8 pixel, and an absolute boundary value of the movement range may be set to 8.

The controller 300 may calculate an accumulated amount of movement by adding the amount of predetermined movement, each time the image area is moved in the first direction. The controller 300 may move the image area in the first direction until the accumulated amount of movement reaches a boundary value of the movement range. Based on the accumulated amount of movement reaching the boundary value of the movement range, the controller 300 may move the image area in the second direction. Each time the image area is moved in the second direction, the controller 300 may subtract the amount of movement from the accumulated amount of movement.

For example, based on the black areas being located on the left side and the right side of the image area, the controller 300 may add the amount of movement (e.g., one pixel) to the accumulated amount of movement, each time the image area is moved by one pixel to the right. Based on the accumulated amount of movement to the right reaching +8, which is the upper limit of the movement range, the controller 300 may move the image area to the left. The controller 300 may subtract the amount of movement (e.g., one pixel) from the accumulated amount of movement, each time the image area is moved by one pixel to the left. Based on the accumulated amount of movement to the left reaching −8, which is the lower limit of the movement range, the controller 300 may move the image area to the right again. Whether the accumulated amount of movement reaches the boundary value of the movement range may be determined by whether an absolute value of the accumulated amount of movement is equal to the maximum absolute value of the movement range.

In an embodiment, the controller 300 may store a final position of the image area, based on the display of the image being stopped. The final position of the image area may be determined by a movement direction of the image area and the accumulated amount of movement. Based on an input of a user command to stop displaying the image through the communication circuitry 420 or the input interface 440, the controller 300 may control the display panel 100 to stop displaying the image. In addition, based on receiving source data of an image different from a currently displayed image through the communication circuitry 420 or the source receiver 430, the controller 300 may control the display panel 100 to stop displaying the image.

Based on an input of a command to resume displaying the image in a state where the image was stopped to be displayed, the controller 300 may move the image area from the final position stored for the image area. The command to resume displaying the image may be input through the communication circuitry 420 or the input interface 440. In addition, based on an input of another source data of another image having the same aspect ratio as the second aspect ratio of the current image, the controller 300 may control the display panel 100 to display the another image at the final position stored for the image area, and may move the image area from the stored final position of the image area. That is, in a case where the images (the current image and the another image) are different, but the aspect ratio of the images is the same as before, a position of the image area may continuously change.

As described above, by periodically or substantially periodically moving the image area in which the image is displayed within the screen S of the display panel 100, local deterioration of the display panel 100 and the occurrence of image retention may be reduced.

FIG. 4 illustrates a driving circuit for driving pixels of a display panel according to an embodiment. FIG. 5 illustrates a configuration of a pixel circuit shown in FIG. 4.

Referring to FIG. 4 and FIG. 5, the panel driver 200 may include the scan driver 210 and the data driver 220. The scan driver 210 may output a gate signal for turning on or off a sub-pixel, and the data driver 220 may output a data signal for implementing an image. That is, the panel driver 200 may generate a gate signal and a data signal based on a driving signal transmitted from the timing controller 310. The panel driver 200 may be implemented as a Display Driver Integrated Circuit (DDIC).

The scan driver 210 may output a gate voltage V_{GATE} based on a scan control signal transmitted from the timing controller 310, and the data driver 220 may output a data voltage V_{DATA} based on a data control signal transmitted from the timing controller 310. The gate voltage V_{GATE} output from the scan driver 210 and the data voltage V_{DATA} output from the data driver 220 may be input to the pixel circuit 130. In response to the gate voltage V_{GATE}, the data voltage V_{DATA}, and a power supply voltage V_{DD} being applied to the pixel circuit 130, the pixel circuit 130 may output a driving current C_{D} for driving the LED 120. The driving current C_{D} output from the pixel circuit 130 may be input to the LED 120, and the LED 120 may emit light by the input driving current C_{D}. Accordingly, an image may be displayed on the screen S of the display panel 100.

The pixel circuit 130 may include a switching transistor TR₁, a driving transistor TR₂, and a capacitor Cₛₜ. The LED 120 may be an OLED. The switching transistor TR₁ and the driving transistor TR₂ may be provided as P-channel Metal-Oxide Semiconductor (PMOS) type transistors, but are not limited thereto. Alternatively, the switching transistor TR₁ and the driving transistor TR₂ may also be provided as N-channel Metal-Oxide Semiconductor (NMOS) type transistors.

A gate electrode of the switching transistor TR₁ is connected to the scan driver 210, a source electrode is connected to the data driver 220, and a drain electrode is connected to one end of the capacitor Cₛₜ and a gate electrode of the driving transistor TR₂. A power supply voltage V_{DD} may be applied to the other end of the capacitor Cₛₜ.

The power supply voltage V_{DD} is supplied to the source electrode of the driving transistor TR₂, and the drain electrode of the driving transistor TR₂ is connected to an anode of the LED 120. A reference voltage V_{SS} may be supplied to a cathode of the LED 120. The reference voltage V_{SS} which is a voltage at a lower level than the power supply voltage V_{DD} may be a ground voltage, and provide a ground.

The pixel circuit 130 may operate as follows. First, when the switching transistor TR₁ is turned on by the gate voltage V_{GATE} applied from the scan driver 210, the data voltage V_{DATA} applied from the data driver 220 may be transferred to one end of the capacitor Cₛₜ and the gate electrode of the driving transistor TR₂. A voltage corresponding to a gate-source voltage V_{GS} of the driving transistor TR₂ may be maintained for a predetermined time by the capacitor Cₛₜ. The driving transistor TR₂ may allow the LED 120 to emit light by applying a driving current C_{D} corresponding to the gate-source voltage V_{GS} to the anode of the LED 120.

In this instance, in response to a high data voltage V_{DATA} being transmitted to the gate electrode of the driving transistor TR₂, the gate-source voltage V_{GS} of the driving transistor TR₂ may be reduced and a small amount of the driving current C_{D} may be applied to the LED 120. Accordingly, the LED 120 may display a low grayscale. On the other hand, in response to a low data voltage V_{DATA} being transmitted, the gate-source voltage V_{GS} of the driving transistor TR₂ may be increased, and a large amount of driving current C_{D} may be applied to the LED 120. Accordingly, the LED 120 may display a high grayscale.

The above-described structure of the pixel circuit 130 is merely an example. Various circuit structures for switching and driving the plurality of LEDs 120 may be applied to the display apparatus 10 in addition to the above examples.

In addition, brightness control of the LED 120 may be performed by various methods. For example, in order to control the brightness of the LED 120, a Pulse Amplitude Modulation (PAM) method, a Pulse Width Modulation (PWM) method, or a hybrid method combining a PAM method and a PWM method may be used.

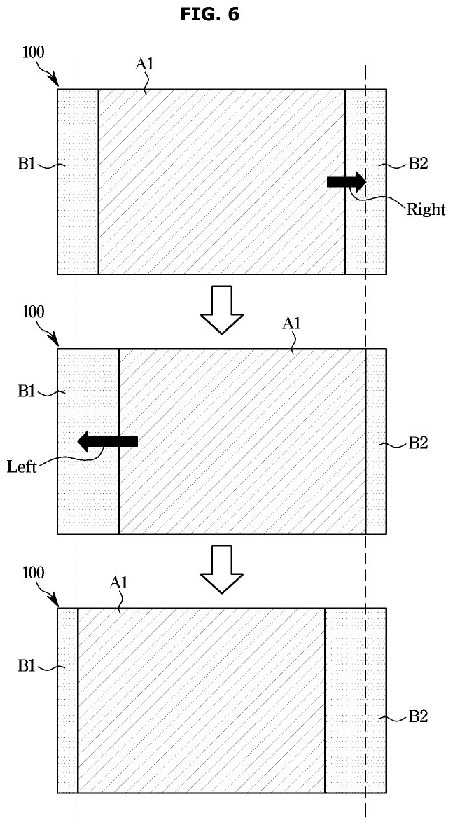

FIG. 6 illustrates an example of moving an image area within a screen of a display panel.

In FIG. 6, a first aspect ratio of the display panel 100 is 16:9 and a second aspect ratio of an image is 4:3. Based on the first aspect ratio of the display panel 100 and the second aspect ratio of the image, the controller 300 may generate black areas B1 and B2 on a left side and a right side of an image area A1, respectively, in which the image is to be displayed. In this case, no black areas may be generated above and below the image area A1. That is, a vertical length of the image area A1 may be the same as a vertical length of the screen S of the display panel 100, and a horizontal length of the image area A1 may be shorter than a horizontal length of the screen S.

Based on the image being first displayed, the controller 300 may position the image area A1 in a center of the screen S of the display panel 100. In other words, an area of the first black area B1 located on the left side of the image area A1 and an area of the second black area B2 located on the right side of the image area A1 may initially be the same. As the image area A1 is moved, the area of the first black area B1 and the area of the second black area B2 may change.

The controller 300 may move the image area A1 in a horizontal direction, as the black areas B1 and B2 are respectively located on the left side and the right side of the image area A1. The image area A1 may be moved by a predetermined amount of movement at each predetermined movement period. For example, first, the controller 300 may move the image area A1 to the right. The controller 300 may move the entire image area A1 to the right by one pixel at each movement period. As described above, a plurality of pixels P are arranged in a matrix form including a plurality of rows and a plurality of columns. Accordingly, moving the entire image area A1 by one pixel to the right refers to moving a column of pixels displaying the image.

The controller 300 may calculate an accumulated amount of movement by adding the amount of movement each time the image area A1 moves to the right. That is, the controller 300 may calculate the accumulated amount of movement by summing (accumulating) the number of pixels that the image area A1 has moved. The controller 300 may move the image area A1 to the right until the accumulated amount of movement reaches an upper limit (e.g., +8 pixel) of a predetermined movement range.

Based on the accumulated amount of movement of the image area A1 reaching the upper limit (e.g., +8 pixel) of the predetermined movement range, the controller 300 may move the image area A1 to the left. The controller 300 may move the image area A1 to the left by one pixel at each predetermined movement period. The controller 300 may subtract, from the accumulated amount of movement, the amount of movement each time the image area A1 moves to the left. The controller 300 may move the image area A1 to the left until the accumulated amount of movement reaches a lower limit (e.g., −8 pixel) of the movement range. Based on the accumulated amount of movement reaching the lower limit of the movement range, the controller 300 may move the image area A1 to the right again. Because the image area A1 moves to the black areas B1 and B2, the image is not cut off even though the entire image area A1 is moved.

Based on display of the image being stopped, the controller 300 may store (memorize) a final position of the image area A1. The final position of the image area A1 may be determined by a movement direction of the image area A1 and the accumulated amount of movement. In a state where the display of the image is stopped, based on a first input of a command to resume displaying the image, or based on a second input of source data of another image having the same aspect ratio as the current image, the controller 300 may move the image area A1 from the stored final position of the image area A1.

For example, the display of the image may be stopped in a state where the accumulated amount of movement of the image area A1 to the right reaching +8 pixel which is the upper limit of the movement range. In this case, the controller 300 may store the final position of the image area A1 as “right +8 pixel”. Thereafter, based on the first input of a command to resume the display of the image, or based on the second input of source data of another image having the same aspect ratio as the current image, the controller 300 may move the image area A1 from the stored final position of the image area A1, i.e., “right +8 pixel”.

Based on the second input of source data of another image having an aspect ratio different from an aspect ratio of the current image, the controller 300 may initialize the accumulated amount of movement of the image area, display the image in the center of the screen S, move the image area from the center of the screen S, and calculate an accumulated amount of movement of the image area again.

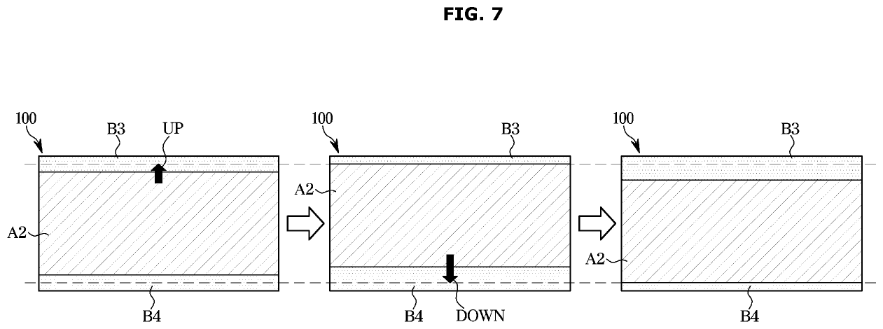

FIG. 7 illustrates another example of moving an image area within a screen of a display panel.

In FIG. 7, a first aspect ratio of the display panel 100 is 16:9 and a second aspect ratio of an image is 21:9. Based on the first aspect ratio of the display panel 100 and the second aspect ratio of the image, the controller 300 may respectively generate black areas (B3 and B4) above and below an image area A2 in which the image is to be displayed. In this case, no black areas may be generated on a left side and a right side of the image area A2. That is, a horizontal length of the image area A2 may be the same as a horizontal length of the screen S of the display panel 100, and a vertical length of the image area A2 may be shorter than a vertical length of the screen S. To distinguish FIG. 7 from FIG. 6, the image area A1 of FIG. 6 may be referred to as a ‘first’ image area, and the image area A2 of FIG. 7 may be referred to as a ‘second’ image area.

Based on the image being first displayed, the controller 300 may position the image area A2 in a center of the screen S of the display panel 100. In other words, an area of the third black area B3 located above the image area A2 and an area of the fourth black area B4 located below the image area A2 may initially be the same. As the image area A2 is moved, the area of the third black area B3 and the area of the fourth black area B4 may change.

The controller 300 may move the image area A2 in a vertical direction, as the black areas B3 and B4 are located above and below the image area A2. For example, the controller 300 may move the image area A2 in an upward direction first. The controller 300 may move the entire image area A2 in the upward direction by one pixel at each movement period. Moving the entire image area A2 upward by one pixel refers to moving a row of pixels displaying the image.

The controller 300 may calculate an accumulated amount of movement by adding the amount of movement each time the image area A2 moves in the upward direction. That is, the controller 300 may calculate the accumulated amount of movement by summing (accumulating) the number of pixels that the image area A2 has moved. The controller 300 may move the image area A2 in the upward direction until the accumulated amount of movement reaches an upper limit (e.g., +8 pixel) of a predetermined movement range.

Based on the accumulated amount of movement of the image area A2 reaching the upper limit (e.g., +8 pixel) of the predetermined movement range, the controller 300 may move the image area A2 in a downward direction. The controller 300 may move the image area A2 in the downward direction by one pixel at each predetermined movement period. The controller 300 may subtract the amount of movement from the accumulated amount of movement each time the image area A2 moves downward. The controller 300 may move the image area A2 in the downward direction until the accumulated amount of movement reaches a lower limit (e.g., −8 pixel) of the movement range. Based on the accumulated amount of movement reaching the lower limit of the movement range, the controller 300 may move the image area A2 upward again. Because the image area A2 moves to the black areas B3 and B4, the image is not cut off even though the entire image area A2 is moved.

In the case of FIG. 7, based on the display of the image being stopped, the controller 300 may also store a final position of the image area A2. In a state where the display of the image is stopped, based on a first input of a command to resume displaying the image, or based on a second input of source data of another image having the same aspect ratio as the current image, the controller 300 may move the image area A2 from the stored final position of the image area A2.

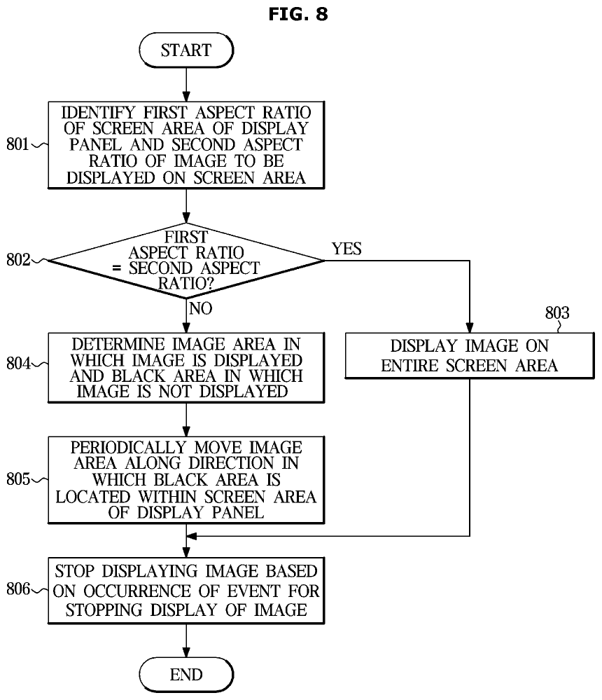

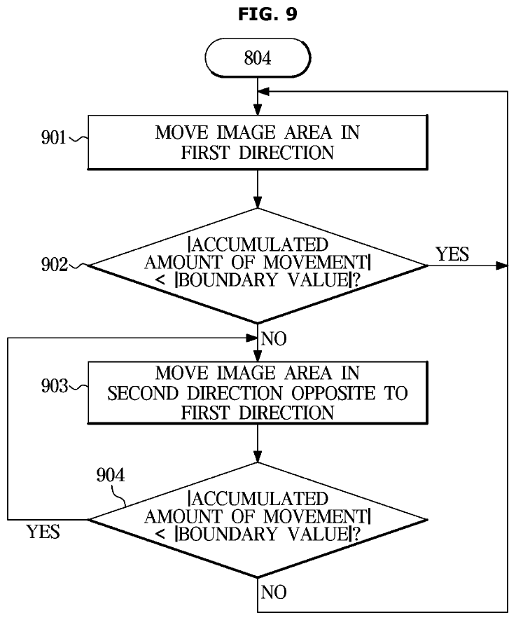

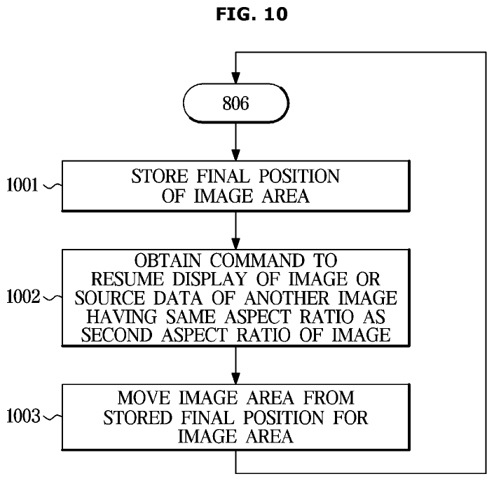

FIG. 8 is a flowchart illustrating a control method of a display apparatus according to an embodiment. FIG. 9 is a flowchart illustrating the control method of the display apparatus of FIG. 8 in more detail. FIG. 10 is a flowchart illustrating a method of determining a position of an image area after display of an image stops.

Referring to FIG. 8, the display apparatus 10 may identify a first aspect ratio of the screen S of the display panel 100 and a second aspect ratio of an image to be output on the screen S (operation 801). Based on the first aspect ratio of the screen S of the display panel 100 being the same as the second aspect ratio of the image to be output on the screen S, the display apparatus 10 may control the display panel 100 to display the image on the entire screen S (operation 802, operation 803).

Based on the first aspect ratio of the screen S of the display panel 100 being different from the second aspect ratio of the image to be output on the screen S, the display apparatus 10 may determine an image area in which the image is displayed and a black area in which the image is not displayed within the screen S of the display panel 100 (operation 802, operation 804).

The display apparatus 10 may periodically or substantially periodically move the image area along a direction in which the black area is located within the screen S of the display panel 100 (operation 805). For example, the controller 300 may move the image area in a vertical direction, based on the black areas being located above and below the image area. The controller 300 may move the image area in a horizontal direction, based on the black areas being located on the left side and the right side of the image area.

Specifically, referring to FIG. 9, the controller 300 of the display apparatus 10 may move the image area in a first direction within the screen S of the display panel 100 (operation 901). For example, based on the black areas being located above and below the image area, the first direction may be an upward direction. Based on the black areas being located on the left side and the right side of the image area, the first direction may be a right direction. The controller 300 may move the image area in the first direction or the second direction opposite to the first direction by a predetermined amount of movement at each predetermined movement period within a predetermined movement range.

The controller 300 of the display apparatus 10 may calculate an accumulated amount of movement by adding the amount of movement each time the image area is moved in the first direction. The controller 300 may move the image area in the first direction until the accumulated amount of movement reaches a boundary value (e.g., an upper limit value) of the movement range (operation 902). Based on the accumulated amount of movement reaching the boundary value (e.g., upper limit value) of the movement range, the controller 300 may move the image area in the second direction opposite to the first direction (operation 903). Each time the controller 300 moves the image area in the second direction, the controller 300 may subtract the amount of movement from the accumulated amount of movement, and may move the image area in the second direction until the accumulated amount of movement reaches a boundary value (e.g., a lower limit value) of the movement range. Based on the accumulated amount of movement reaching the boundary value (e.g., a lower limit value) of the movement range again, the controller 300 may move the image area in the first direction again (operation 904). Whether the accumulated amount of movement reaches a boundary value of movement range may be determined by whether an absolute value of the accumulated amount of movement is equal to a maximum absolute value of the movement range.

Referring again to FIG. 8, the display apparatus 10 may stop displaying the image (operation 806) based on an occurrence of an event for stopping the display of the image. For example, based on an input of a user command to stop displaying the image through the communication circuitry 420 or the input interface 440, the controller 300 of the display apparatus 10 may identify that the event for stopping the display of the image has occurred, and may control the display panel 100 to stop displaying the image. In addition, based on receiving source data of an image different from the currently displayed image through the communication circuitry 420 or the source receiver 430, the controller 300 of the display apparatus 10 may identify that an event for stopping the display of the image has occurred, and may control the display panel 100 to stop displaying the image.

Referring to FIG. 10, the display apparatus 10 may store a final position of the image area based on the display of the image being stopped (operation 1001). In a state where the display of the image stops, the display apparatus 10 may obtain a command to resume the display of the image or source data of another image having the same aspect ratio as the second aspect ratio of the current image (operation 1002). The display apparatus 10 may move the image area from the final position stored for the image area according to the command to resume the display of the image. Further, based on the input of source data of the other image having the same aspect ratio as the second aspect ratio of the current image, the display apparatus 10 may control the display panel 100 to display the other image at the final position stored for the image area, and may move the image area from the stored final position of the image area (operation 1003).

As described above, according to an embodiment of the disclosure, the display apparatus 10 may include the display panel 100 including a plurality of organic light emitting diodes; and the controller 300 configured to process source data received from an external device to control the display panel to display an image on a screen of the display panel. The controller 300 may identify a first aspect ratio of the screen of the display panel and a second aspect ratio of the image. The controller 300 may determine an image area where the image is displayed and a black area where the image is not displayed within the screen of the display panel, based on the first aspect ratio being different from the second aspect ratio. The controller 300 may periodically or substantially periodically move the image area along a direction in which the black area is located within the screen of the display panel.

The controller may move the image area in a vertical direction, based on the black areas being located above and below the image area, or move the image area in a horizontal direction, based on the black areas being located on a left side and a right side of the image area.

The controller may move the image area in a first direction or a second direction opposite to the first direction by a predetermined amount of movement at each predetermined movement period within a predetermined movement range.

The controller may move the entire image area by a unit pixel at each of the movement periods.

The controller may calculate an accumulated amount of movement by adding the amount of movement each time the image area is moved in the first direction, move the image area in the first direction until the accumulated amount of movement reaches a maximum absolute value of the movement range, and in response to the accumulated amount of movement reaching the maximum absolute value of the movement range, move the image area in the second direction.

The controller may subtract, from the accumulated amount of movement, the amount of movement each time the image area is moved in the second direction.

The controller may store a final position of the image area, based on display of the image being stopped, based on an input of a command to resume the display of the image or an input of source data of another image having a same aspect ratio as the second aspect ratio of the image, determine movement of the image area from the final position of the image area.

According to an embodiment of the disclosure, the control method of the display apparatus including the display panel 100 including a plurality of organic light emitting diodes and the controller 300 configured to control the display panel may include: identifying, by the controller, a first aspect ratio of a screen of the display panel and a second aspect ratio of an image to be displayed on the screen; based on the first aspect ratio being different from the second aspect ratio, determining, by the controller, an image area where the image is displayed and a black area where the image is not displayed within the screen of the display panel; and periodically or substantially periodically moving, by the controller, the image area along a direction in which the black area is located within the screen of the display panel.

The periodically or substantially periodically moving of the image area may include moving the image area in a vertical direction, based on the black areas being located above and below the image area; and moving the image area in a horizontal direction, based on the black areas being located on a left side and a right side of the image area.

The periodically or substantially periodically moving of the image area may include moving the image area in a first direction or a second direction opposite to the first direction by a predetermined amount of movement at each predetermined movement period within a predetermined movement range.

The periodically or substantially periodically moving of the image area may include moving the entire image area by a unit pixel at the each predetermined movement period.

The periodically or substantially periodically moving of the image area may include calculating an accumulated amount of movement by adding the amount of predetermined movement each time the image area is moved in the first direction; moving the image area in the first direction until the accumulated amount of movement reaches a boundary value of the movement range, and in response to the accumulated amount of movement reaching the boundary value of the movement range, moving the image area in the second direction.

The moving of the image area in the second direction may include subtracting the amount of movement from the accumulated amount of movement, each time the image area is moved in the second direction.

The control method may further include: storing a final position of the image area based on display of the image being stopped; and based on an input of a command to resume the display of the image or an input of source data of another image having a same aspect ratio as the second aspect ratio of the image, determining movement of the image area from the final position of the image area.

As described above, the display apparatus and the control method thereof may reduce local deterioration of a self-luminous display panel and an occurrence of image retention, and thus a lifespan of the self-luminous display panel may be increased.

The disclosed embodiments may be implemented in the form of a recording medium that stores instructions executable by a computer. The instructions may be stored in the form of program codes, and when executed by a processor, the instructions may create a program module to perform operations of the disclosed embodiments.

The machine-readable recording medium may be provided in the form of a non-transitory storage medium. The term ‘non-transitory storage medium’ may mean a tangible device without including a signal (e.g., electromagnetic waves) and may not distinguish between storing data in the storage medium semi-permanently and temporarily. For example, the non-transitory storage medium may include a buffer that temporarily stores data.

The method according to the various embodiments of the disclosure may be provided in a computer program product. The computer program product may be a commercial product that may be traded between a seller and a buyer. The computer program product may be distributed in the form of a storage medium (e.g., a compact disc read only memory (CD-ROM)), through an application store (e.g., Play Store™), directly between two user devices (e.g., smartphones), or online (e.g., downloaded or uploaded). In the case of online distribution, at least part of the computer program product (e.g., a downloadable app) may be at least temporarily stored or arbitrarily created in a storage medium that may be readable to a device such as a server of the manufacturer, a server of the application store, or a relay server.

Although the disclosure has been shown and described in relation to specific embodiments, those skilled in the art that changes and modifications may be made in these embodiments without departing from the principles and scope of the disclosure, the scope of which is defined in the claims and their equivalents.

What is claimed is:

1. An display apparatus comprising:
a display panel; and
a controller configured to:
process source data including an image data, received from an external device, to control the display panel to display an image on a screen of the display panel,
identify a first aspect ratio of the screen of the display panel and a second aspect ratio of the image,
based on the first aspect ratio being different from the second aspect ratio, determine, within the screen of the display panel, an image area where the image is displayed and a black area where the image is not displayed, and
move the image area periodically along a direction in which the black area is located within the screen of the display panel.

2. The display apparatus of claim 1, wherein the controller is further configured to:
based on the black area being located above and below the image area, move the image area in a vertical direction, or
based on the black area being located on a left side and a right side of the image area, move the image area in a horizontal direction.

3. The display apparatus of claim 1, wherein the controller is further configured to move the image area in a first direction or a second direction opposite to the first direction by a predetermined amount of movement at each predetermined movement period within a predetermined movement range.

4. The display apparatus of claim 3, wherein the controller is further configured to move the image area by a unit pixel at each predetermined movement period.

5. The display apparatus of claim 3, wherein the controller is further configured to:
determine an accumulated amount of movement by adding the predetermined amount of movement each time the image area is moved in the first direction,
move the image area in the first direction until the accumulated amount of movement reaches a maximum absolute value of the predetermined movement range, and
based on the accumulated amount of movement reaching the maximum absolute value of the predetermined movement range, move the image area in the second direction.

6. The display apparatus of claim 5, wherein the controller is further configured to subtract, from the accumulated amount of movement, the predetermined amount of movement each time the image area is moved in the second direction.

7. The display apparatus of claim 5, wherein the controller is further configured to:
based on display of the image being stopped, store a final position of the image area, and
based on a first input of a command to resume displaying the image or based on a second input of another source data comprising another image having a same aspect ratio as the second aspect ratio of the image, determine a movement of the image area from the final position of the image area.

8. A control method of a display apparatus comprising a display panel and a controller configured to control the display panel, the control method comprising:
identifying, by the controller, a first aspect ratio of a screen of the display panel and a second aspect ratio of an image to be displayed on the screen;
based on the first aspect ratio being different from the second aspect ratio, determining, within the screen of the display panel, by the controller, an image area where the image is displayed and a black area where the image is not displayed; and
moving, by the controller, the image area periodically along a direction in which the black area is located within the screen of the display panel.

9. The control method of claim 8, wherein the moving the image area comprises:
based on the black area being located above and below the image area, moving the image area in a vertical direction; and
based on the black area being located on a left side and a right side of the image area, moving the image area in a horizontal direction.

10. The control method of claim 8, wherein the moving the image area comprises moving the image area in a first direction or a second direction opposite to the first direction by a predetermined amount of movement at each predetermined movement period within a predetermined movement range.

11. The control method of claim 10, wherein the moving the image area comprises moving the image area by a unit pixel at each predetermined movement period.

12. The control method of claim 10, wherein the moving the image area comprises:
determining an accumulated amount of movement by adding the predetermined amount of movement each time the image area is moved in the first direction;
moving the image area in the first direction until the accumulated amount of movement reaches a boundary value of the predetermined movement range, and
based on the accumulated amount of movement reaching the boundary value of the predetermined movement range, moving the image area in the second direction.

13. The control method of claim 12, wherein the moving the image area in the second direction comprises subtracting, from the accumulated amount of movement, the predetermined amount of movement each time the image area is moved in the second direction.

14. The control method of claim 12, further comprising:
based on the image being stopped displayed on the image area of the display panel, storing a final position of the image area; and
based on a first input of a command to resume displaying the image or a second input of another source data comprising another image having a same aspect ratio as the second aspect ratio of the image, determining movement of the image area from the final position of the image area.

15. A display apparatus comprising:
a display panel comprising a screen;
a memory storing at least one instruction; and
at least one processor operatively connected to the display panel and the memory,
wherein the at least one processor is configured to execute the at least one instruction to:
receive source data from an external device,
control the display panel to display an image on the screen, wherein the image is included in the source data,
identify a first aspect ratio of the screen and a second aspect ratio of the image,
based on the first aspect ratio being different from the second aspect ratio, determine an image area where the image is displayed and a plurality of black areas where the image is not displayed, and
move the image area periodically along a plurality of directions in which the plurality of black areas are located.

16. The display apparatus of claim 15, wherein the at least one processor is further configured to execute the at least one instruction to:
based on the plurality of black areas being located above and below the image area, move the image area in a vertical direction, or
based on the plurality of black areas being located on a left side and a right side of the image area, move the image area in a horizontal direction.

17. The display apparatus of claim 15, wherein the at least one processor is further configured to execute the at least one instruction to move the image area in a first direction or a second direction opposite to the first direction by an amount of movement at a movement period within a movement range.

18. The display apparatus of claim 17, wherein the at least one processor is further configured to execute the at least one instruction to move the image area by a unit pixel at the movement period.

19. The display apparatus of claim 17, wherein the at least one processor is further configured to execute the at least one instruction to:
determine an accumulated amount of movement by adding the amount of movement each time the image area is moved in the first direction,
move the image area in the first direction until the accumulated amount of movement reaches a maximum absolute value of the movement range, and
based on the accumulated amount of movement reaching the maximum absolute value of the movement range, move the image area in the second direction.

20. The display apparatus of claim 19, wherein the at least one processor is further configured to execute the at least one instruction to subtract, from the accumulated amount of movement, the amount of movement each time the image area is moved in the second direction.
